(19) United States
(12) Patent Application Publication
(10) Pub. No.: US 2004/0048540 A1
(43) Pub. Date: Mar. 11, 2004

(54) Fabric for garment and resulting garment

(76) Inventor: Gerard Dailly, Colmar (FR)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/470,028

(22) PCT Filed: Jan. 22, 2002
(86) PCT No.: PCT/FR02/00238

(30) Foreign Application Priority Data
Jan. 22, 2001 (FR) 0100914

(51) Int. Cl. D04B 1/14; D04B 1/18; B32B 5/02; D04B 21/14

(52) U.S. Cl. 442/308; 442/91; 442/309; 442/310; 442/306

(57) ABSTRACT

A technical fabric is disclosed that combines sweat-repellent and thermally insulating characteristics, which is easy to produce, which is economical, effective and reliable over time, and which provides absolute comfort for the athlete or any individual wearing a garment manufactured from this fabric, regardless of the physical exertion made and the climatic conditions in cold as well as in heat.

This technical fabric has at least two superposed layers, a first layer, called interior layer, intended for being in direct contact with the skin, and a second layer, called exterior layer. The interior layer is produced from synthetic fibers with a small quantity of strands promoting evacuation of the water molecules by capillary action from the skin to the exterior, and the exterior layer is produced from hollow synthetic fibers promoting evacuation of the water molecules from the interior layer to the exterior and good thermal insulation. These two layers are assembled closely by a knitting process with incorporation of an elastic thread.

### FIELD OF THE INVENTION

The present invention relates to a technical fabric for a garment, this fabric having sweat-repellent and thermally insulating characteristics, and having at least two superposed layers produced from synthetic fibers with different physical characteristics, a first layer, called the interior layer, intended for being in direct contact with the skin, and a second layer, called the exterior layer. The invention also relates to a garment obtained with said technical fabric.

### BACKGROUND OF THE INVENTION

Under certain conditions, garments with the characteristics mentioned above are sought. This is the case, for example, for athletic activities requiring sustained exertion over a relatively long duration practiced outside at relatively low temperatures, such as cycling, foot racing, mountaineering, skiing, hiking, etc. In a general manner, physical exertion increases the secretion of sweat by the body. If the drops of sweat are not evacuated, the skin remains moist, and the athlete will not be comfortable. Moreover, if the surrounding temperature is low, close to zero or below zero, the body will cool down very quickly which can lead to health problems, such as thermal shock and/or muscle problems.

A number of solutions exist for solving this problem. One of the solutions consists of equipping the athlete with several garments and particularly a first sweat-repellent garment which ensures the evacuation of the moisture to the exterior and a second thermally insulating garment. Another solution consists of equipping the athlete with a single garment combining the functions of moisture evacuation and thermal insulation. However, the fabric used for manufacturing this type of clothing generally entails a synthetic membrane provided with microperforations allowing the water vapor to pass through and protecting from cold. This solution is not optimal because the microperforations have the disadvantage of rapidly becoming saturated with moisture in the case of great and intense exertion. Once the microperforations are saturated, the moisture condenses inside the fabric. Consequently, these microperforations no longer fulfill their breathing function and leave the athlete in complete discomfort.

Other solutions have attempted to circumvent this problem by producing fabrics which breathe. The publication U.S. Pat. No. 5,787,503 describes a garment consisting of two independent layers which are superposed and assembled by stitching in order to form pockets of air capable of retaining the body heat and thus creating thermal insulation. Each layer is composed of two knits. The interior layer, provided for being in contact with the skin, is produced from Coolmax® absorbent fibers which are capable of rapidly evacuating the sweat. The exterior layer is produced from a mixture of wool/breathing acrylic fibers. It is then coated with Teflon HT® so that it is impermeable and stain-repellant. This embodiment is particularly expensive since it requires the manufacturing of two separate fabrics which need to be assembled by stitching.

The publication DE-A-195 47 704 describes a fabric made up of two layers knit or woven separately and assembled together. The interior layer, provided for being in contact with the skin, is hydrophilic and is produced from relatively coarse continuous filaments in order to rapidly absorb the sweat. The exterior layer is also hydrophilic but is produced from finer continuous filaments in order to evacuate the sweat. The filaments used for the two layers are identical and can be made of polyester, nylon or acrylic. This embodiment is limited to a sweat-repellent effect and does not combine any thermal insulation effect.

The publication WO-A-98/56267 describes a so-called thermoregulating garment composed of a hydrophilic base fabric made of Coolmax® for absorbing and evacuating the sweat. Connected inside of the garment by stitching are panels produced out of hollow Thermastat® fibers for storing body heat. These panels are placed directly in contact with the skin and only facing the muscles. They are not provided for covering the whole body since they have no absorption or sweat evacuation function. This embodiment is not optimal since a sweat-repellent effect is obtained on the parts of the body covered with the base fabric, and in a dissociated manner, a thermal insulation effect is obtained on the parts covered with the panels.

### SUMMARY OF THE INVENTION

The present invention represents an improvement over these disadvantages by providing a technical fabric which combines the characteristics of moisture evacuation and thermal insulation, which is easy to produce, which is economical, effective and reliable over time, regardless of the quantity of moisture to be evacuated, and which consequently provides absolute comfort for the athlete or any individual wearing a garment manufactured from this fabric.

The invention relates to a technical fabric characterized by the fact that an interior layer is produced from synthetic fibers with a small quantity of strands promoting evacuation of the water molecules by capillary action from the skin to the exterior, by the fact that an exterior layer is produced from hollow synthetic fibers promoting both evacuation of the water molecules from the interior layer to the exterior and good thermal insulation, and by the fact that these layers are assembled closely by a process of knitting with incorporation of an elastic thread.

The fibers of the interior layer can be polyester fibers, and the fibers of the exterior layer can be polyester microfibers marketed by Dupont de Nemours under the brand Thermolite® Base. As for the elastic thread, it can consist of a synthetic filament marketed by Dupont de Nemours under the brand Lycra®.

Advantageously, the interior layer can be associated with a mechanical treatment, such as a scraping or emery treatment operation, promoting its characteristics of evacuation of the water molecules.

Preferably, the elastic thread is included in the composition of the fabric equal to a percentage between 2 and 10%. The synthetic fibers of the interior and exterior layer can be distributed according to a roughly equal percentage.

The knitting process used for intimately assembling the fibers of the interior and exterior layers is preferably a so-called interlock process.

The invention also relates to a technical garment which has sweat-repellent and thermally insulating characteristics, which is characterized by the fact that it is produced with the technical fabric as defined above.

### BRIEF DESCRIPTION OF THE DRAWING

The present invention and its advantages will appear more clearly in the following description of an embodiment example, in reference to the appended drawings in which:

FIG. 1 is an enlarged diagram illustrating the technical characteristics of the technical fabric according to the invention,

FIG. 2 is an enlarged sectional view of an embodiment example of the fabric of FIG. 1, and

FIG. 3 is a representation of the weft of the fabric of FIG. 2.

### DETAILED DESCRIPTION OF THE DRAWINGS

In reference to the figures, technical fabric 1 according to the invention is intended for manufacturing any type of garment, and particularly garments and undergarments worn close to the body such as tight-fitting jerseys, shorts, briefs, tights, socks, hoods, undergloves, etc.

This technical fabric 1 has two superposed layers, a first layer, called interior layer 2, intended for being in direct contact with the skin, and a second layer, called exterior layer 3. Interior layer 2 has a sweat-repellent function and is produced from synthetic fibers which promote suction and evacuation of the moisture, particularly the water molecules, by capillary action, from the skin to the exterior. The exterior layer has a thermal insulation function and is produced from synthetic fibers which also promote evacuation of the water molecules from the interior layer to the exterior but which moreover provide excellent thermal insulation.

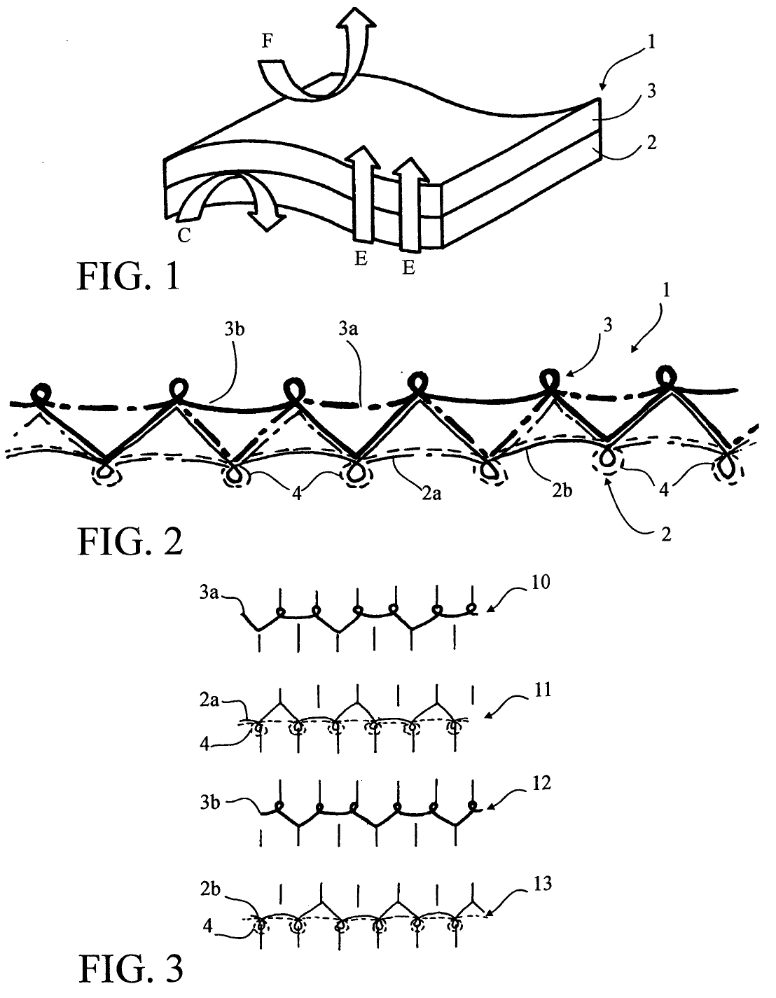

The diagram of FIG. 1 makes it possible to illustrate these phenomena. The water molecules, represented by arrows E, are suctioned by interior layer 2 by capillary action and successively pass through interior layer 2 and then exterior layer 3 to the point of being evacuated by the surrounding air. These water molecules transport with them the calories produced by the body in motion. These calories, represented by arrows C, pass through interior layer 2 and are then stored in exterior layer 3. Furthermore, the negative kilocalories of the surrounding air, represented by arrow F, are stopped by exterior layer 3 which prevents their penetration through the fabric and their contact with the skin. The thermal insulation produced by exterior layer 3 considerably slows the thermal exchanges between the skin and the surrounding air and makes it possible to maintain the body at an optimal temperature for avoiding cooling of the athlete.

In order to obtain an optimal yield from technical fabric 1 and a balance between the characteristics of moisture evacuation and thermal insulation, the synthetic fibers of interior layer 2 and those of the exterior layer are distributed according to a roughly equal percentage.

This technical fabric also has at least one elastic thread 4, for example, consisting of a continuous filament marketed by Dupont de Nemours under the brand Lycra®. The integration of this elastic filament 4 makes it possible to produce an extensible technical fabric which allows the manufacturing of garments and undergarments intended for being worn close to the body in order to promote the thermal exchange between the body and technical fabric 1. This elastic thread 4 produces a spring effect and thus allows technical fabric 1 to be always in contact with the body. Without the body/fabric contact, the thermal exchange no longer occurs, and the sweat repellent and thermal insulation effects of technical fabric 1 are inhibited.

The composition of this technical fabric 1 can comply with the following percentages, which are given only as a nonlimiting example:

48.25% fibers for interior layer 2,

48.25% fibers for the exterior layer 4, and

3.5% elastic filament 4.

Depending on the desired results, these percentages can vary, for example, within a bracket of 45-49% for the fibers of the interior 2 and exterior 3 layers and 2-10% for the elastic filament.

As a nonlimiting example, the fibers of interior layer 2 are traditional polyester fibers but which are formed by a reduced number of strands, for example, equal to 36 strands. It is this small quantity of strands which promotes the suction and evacuation of the moisture to the exterior. As a nonlimiting example, the fibers of exterior layer 3 are polyester microfibers marketed by Dupont de Nemours under the brand Thermolite® Base. The microfibers of exterior layer 3 have the particular characteristic of being hollow fibers which promote storage of calories and increase the power of thermal insulation of this layer.

As a nonlimiting example, technical fabric 1 of the invention can be made up of a mesh fabric produced by knitting on a circular loom. Of course, any other equivalent process can be used. An embodiment example is illustrated by FIG. 2 which represents a diagrammatic sectional view of a meshwork-forming technical fabric 1 of the invention. The weft representation allowing one to obtain this meshwork is illustrated by FIG. 3. This pertains to a double-sided reinforcement obtained according to a process known in the profession as “interlock” and which requires four mesh rows 10-13. Row 10 is cast on with the fibers of exterior layer 3, which are referenced 3a. Row 11 is cast on with the fibers of interior layer 2, which are referenced 2a, and with elastic filament 4. Row 12 is cast on with the fibers of exterior layer 3, which are referenced 3b. Row 13 is cast on with the fibers of interior layer 2, which are referenced 2b, and with elastic filament 4. This type of casting on allows one to obtain a mesh fabric composed of two distinct layers 2, 3 but which are connected together, with fibers 2a, 2b of interior layer 2 not passing through exterior layer 3 and conversely.

After knitting, this technical fabric 1 is present in the form of a tubular sleeve approximately 80 cm wide and 40-50 meters long. It is then opened to form a strip of fabric which must be stretched to the desired width and density and then heat-set. Then, this technical fabric 1 can, like any fabrics, undergo different finishing treatments depending on its use. It can, for example, undergo degreasing, presetting before dyeing and then dyeing.

Generally, interior layer 2 of technical fabric 1 undergoes an additional mechanical treatment, such as a scraping or emery treatment operation. This operation allows one to make the strands emerge from the surface of the fabric, strands whose function is to soften the feel of the fabric and therefore the contact with the skin, but also to increase the power of evacuation of the water molecules by capillary action.

After finishing of technical fabric 1, this fabric is cut and then cast on in order to produce any type of garments or undergarments. These garments or undergarments should be worn close to the body in order to attain the best performances.

It clearly appears from the description that the invention makes it possible to attain the aims which were set. From an economic standpoint, this technical fabric can be produced by known techniques and processes. Likewise, the fibers which compose it are commercially available fibers. The garment produced with this technical fabric has the advantage of combining the effects of two superposed garments. Thus, considerable savings are obtained in the manufacturing of the fabric, since this manufacturing is limited to a single fabric, as well as in the making of the garment, since the cutting, casting on, assembling operations are limited to a single garment. Moreover, just one product reference needs to be managed.

Since this technical fabric is formed by two closely connected superposed layers, the technical performances of the garment obtained are clearly improved in comparison with the performances attained by the superposing of two distinct garments. Finally, the garment obtained by this technical fabric provides the athlete or any individual who wears it with unequaled comfort, great ease of motion, a light weight and optimal thermal protection, even under the harshest climatic conditions.

The tests carried out in different situations in cold down to −30° C. as well as in heat up to +50° C., in motion as well as at rest, have demonstrated that this technical fabric produces a thermoregulating effect in the manner of the human body and acts as a second skin. This result is completely unexpected and has never been possible to attain with the superposing of two independent fabrics. Moreover, this extensible technical fabric which rapidly evacuates the sweat to the exterior dries very quickly and does not develop any foul odor.

The present invention is not limited to the embodiment example which has been described but extends to any modification and variant obvious to the expert in the field. In particular, other fibers or microfibers can be used provided that they correspond to the same technical characteristics. Likewise, the garment obtained by the technical fabric of the invention can be used in various domains and not exclusively in the domain of athletics.

What is claimed is:

1. A technical fabric (1) for garments, this fabric having sweat-repellent and thermally insulating characteristics, and having at least two superposed layers (2,3) produced from synthetic fibers with different physical characteristics, a first layer, called interior layer (2), intended for being in direct contact with the skin, and a second layer, called exterior layer (3), characterized by the fact that interior layer (2) is produced from synthetic fibers with a small quantity of strands promoting evacuation of the water molecules by capillary action from the skin to the exterior, by the fact that exterior layer (3) is produced from hollow synthetic fibers promoting both evacuation of the water molecules from the interior layer to the exterior and good thermal insulation, and by the fact that these layers (2,3) are assembled closely by a process of knitting with incorporation of elastic thread (4).

2. A technical fabric according to claim 1, characterized by the fact that the synthetic fibers of interior layer (2) are polyester fibers.

3. A technical fabric according to claim 1, characterized by the fact that interior layer (2) is associated with a mechanical treatment promoting its characteristics of evacuation of the water molecules.

4. A technical fabric according to claim 3, characterized by the fact that this mechanical treatment is a scraping or emery treatment operation.

5. A technical fabric according to claim 1, characterized by the fact that the hollow synthetic fibers of exterior layer (3) are polyester microfibers marketed by Dupont de Nemours under the brand Thermolite® Base.

6. A technical fabric according to claim 1, characterized by the fact that elastic thread (4) consists of a synthetic filament marketed by Dupont de Nemours under the brand Lycra®.

7. A technical fabric according to claim 1, characterized by the fact that elastic thread (4) is included in the composition of said fabric equal to a percentage between 2 and 10%.

8. A technical fabric according to claim 1, characterized by the fact that the synthetic fibers of the interior (2) and exterior (3) layers are distributed according to a roughly equal percentage.

9. A technical fabric according to claim 1, characterized by the fact that the knitting process is a so-called interlock process.

10. A technical garment which has sweat repellent and thermally insulating characteristics, characterized by the fact that it is produced with technical fabric (1) as defined in any one of the preceding claims.
